(19) United States
(12) Patent Application Publication
(10) Pub. No.: US 2017/0144096 A1
(43) Pub. Date: May 25, 2017

(54) FIRE RESISTANT VACUUM FILTER

(71) Applicant: DUSTLESS DEPOT, LLC, Price, UT (US)

(72) Inventors: Allen Chen, Jinhua City (CN); Zhifeng Xia, Jinhua City (CN)

(73) Assignee: DUSTLESS DEPOT, LLC, Price, UT (US)

(21) Appl. No.: 14/952,550

(22) Filed: Nov. 25, 2015

(51) Int. Cl. B01D 46/00; B01D 39/16

(52) U.S. Cl. CPC B01D 46/0093; B01D 39/16; B01D 2275/10; B01D 2239/0478

(57) ABSTRACT

A vacuum filter which is resistant to hot debris and which prevents damage to the vacuum when damaged is disclosed. The vacuum filter may include a filter element which is formed of multiple layers of different material. The filter element may include an upstream layer of filter material which is exposed to incoming debris and which filters debris from air moving through a vacuum, a firebreak layer disposed adjacent the upstream layer of filter material and disposed downstream of the upstream layer of filter material, and a downstream layer of filter material which is disposed downstream of the firebreak layer. The firebreak layer and downstream layer of filter material may prevent damage to the vacuum and maintain the filtration ability of the filter if the upstream layer of filter material is damaged.

### THE FIELD OF THE INVENTION

The present invention relates to vacuum filters. More specifically, the present invention relates to an improved vacuum filter which may be used to collect materials which may contain hot materials such as sparks or ash.

### BACKGROUND

It is often desirable to use a vacuum to collect debris which may contain hot materials. For example, it is often convenient to use a vacuum to collect ash from fireplace. Many existing vacuum filters are not suitable for this use. It is desirable to have a vacuum bag which is better suited for collecting debris which may contain hot materials.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a drawing which shows a vacuum and a vacuum filter.

FIG. 2 is a drawing which shows the vacuum and vacuum filter.

FIG. 3 is a drawing which shows the vacuum filter.

FIG. 4 is a drawing detailing a portion of the filter media forming the vacuum filter.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combination and/or sub-combinations in one or more embodiments or examples. In addition, it is appreciated that the figures provided herewith are for explanation purposes to persons ordinarily skilled in the art and that the drawings are not necessarily drawn to scale.

The disclosure particularly describes a vacuum filter which is more resistant to hot materials. Particularly, the present disclosure describes a vacuum filter which is more resistant to damage from contact with hot materials and which will continue to function as a filter and to protect the vacuum motor from damage when the filter has been damaged by hot materials.

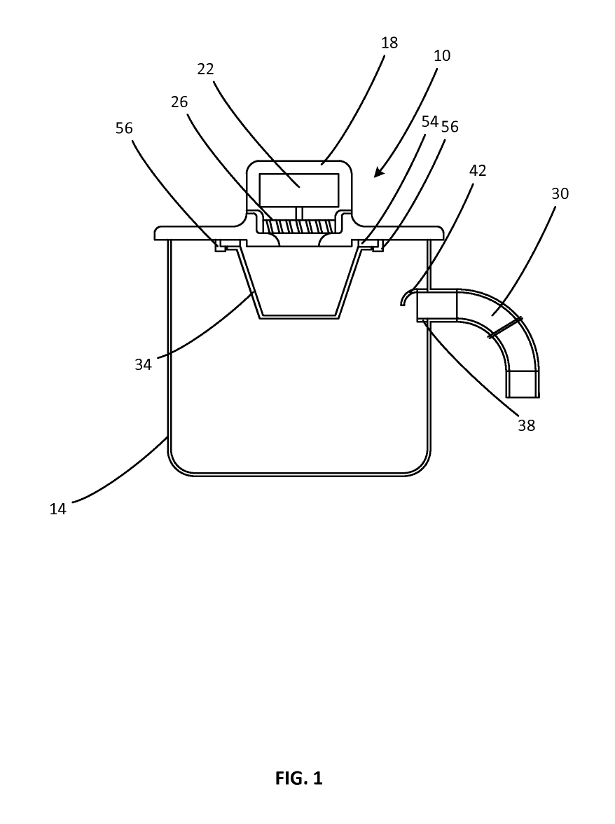

Vacuums are commonly used to collect debris. Portable canister vacuums, or shop vacuums, are increasingly common. Referring to FIG. 1, these vacuums 10 typically have a canister 14, which often has a volume from 1 to 15 or more gallons, and a canister lid 18. The canister lid typically contains the vacuum motor 22 and impeller/fan 26. Air moves through a vacuum hose 30 and into the canister 14, through the lid 18, motor fan 26 and motor 22, and out of the vacuum 10 through the top of the lid 18. A filter 34 is used to remove debris which is entrained in the moving air and trap the debris in the vacuum 10 so that clean air may flow out of the vacuum. The filter 34 may often be cylindrical or conically shaped and may attach to the vacuum canister lid 18 so that any air passing through the vacuum motor passes through the filter. Air flows through the hose 30 and into the canister 14, through the filter 34, and through the lid 18, motor fan 26 and motor 22, and out of the vacuum 10. Alternatively, a bag filter may be attached to the canister inlet 38 and air flows through the hose 30 and into the filter 34, through the filter 34, and through the lid 18, motor fan 26 and motor 22, and out of the vacuum 10. When a conical or cylindrical filter is attached to the canister lid 18, the vacuum is often used with an inlet diverter 42 which directs air towards the bottom of the vacuum canister to direct debris away from the filter 34. This serves to lengthen the cleaning or replacement interval for the filter 34. The debris collects in the canister 14 during use and is emptied by removing the lid and dumping out the canister or removing a filter bag.

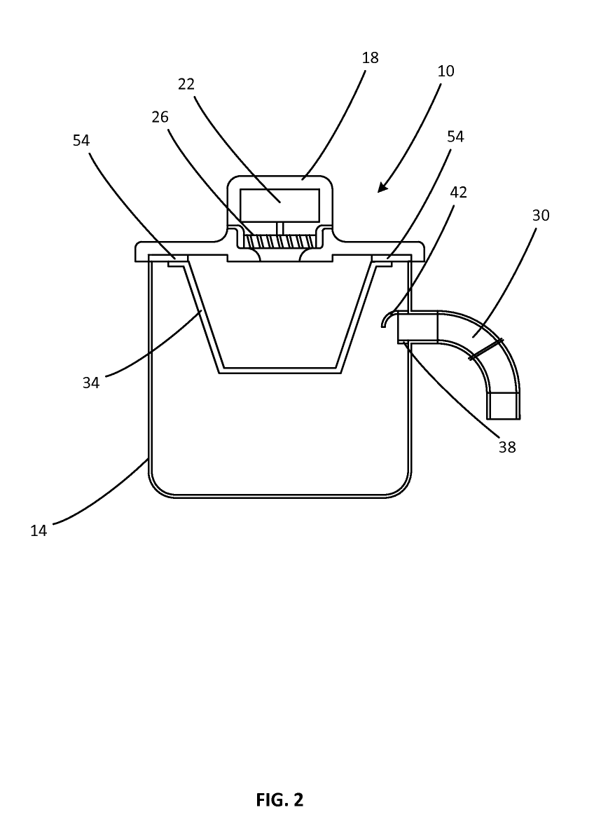

FIG. 1 shows a canister filter 34 which has been attached to the canister lid 18. The filter 34 may be cylindrical or frustoconical in shape. As shown in FIG. 1, the filter 34 may include a flange or collar 54. The filter media may be attached to the flange 54. For an example filter, the flange 54 may be round and have an opening in the center thereof. The flange 54 may be attached to the vacuum canister lid 18 with one or more clamps or brackets 56. Alternatively, the flange 54 may be captured in an elastic mounting flange on the lid 18, or the flange 54 may be made of an elastic material and placed into or around a collar on the lid 18. FIG. 2 shows another version of the filter 34 which has an enlarged attachment flange or collar 54 and which attaches to the upper edges of the canister 14. The filter flange 54 may be held between the canister 14 and canister lid 18 and secured by clamps, etc. which are used to hold the lid 18 to the canister 14. Both examples of the filter 34 are formed with the same basic structures.

These vacuums are often used to collect debris which may damage the filter 34. As mentioned, canister vacuums are often used to clean ash from a fireplace. Even though the ash is collected after the fire is dead and the ash has cooled, it is not uncommon to find small pieces of hot ash or hot embers in the fireplace ash. The ash is quite insulating and allows an ember to maintain a high temperature for a long period of time. The ash also impedes contact between an ember and air and slows the burning of the ember. As a result, fireplace ash may contain hot embers days after the last fire. Particularly in cold seasons, a user may not be able to wait sufficiently long after a fire for the ash to completely cool because they may need to light another fire to heat their home.

The filter 34 has been designed to provide additional resistance to damage from hot sparks, ash, embers, etc. The filter 34 has also been designed to still provide filtration after the filter has been damaged so that the vacuum motor 22 and fan 26 are protected from damage and so that dust is not ejected from the vacuum. While the filter 34 may need to be replaced after contact with a quantity of hot material, the vacuum itself and the surrounding environment are protected from the effects of filter failure.

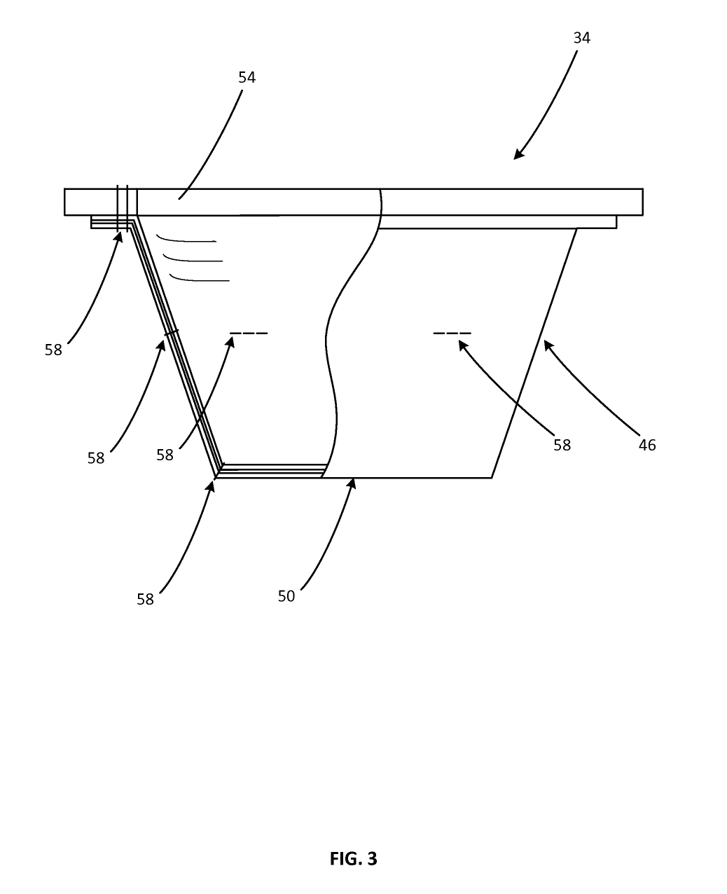

Turning now to FIG. 3, a cross sectional view of the vacuum filter 34 is shown. The example filter 34 is formed in a frustoconical shape and has side walls 46 and a bottom wall 50 formed from different layers which make up the filter material. The upper surface of the filter material is attached to a flange 54. The flange 54 may be an elastomeric or plastic ring and has a hole formed therethrough inside of the filter material so that air flows through the filter material, through the hole in the flange 54, and out of the vacuum. The flange 54 may be generally circular and have a generally circular opening. The filter material is typically sewn together to form the desired filter shape and is also sewn to the plastic ring 54, although different methods of attachment may be used. The layers of filter material may be sewn together at the corners and edges of the filter 34 and also sewn together at additional locations to keep these layers together during use of the filter 34. Such stitches are indicated at 58. The flange 54 is attached to the vacuum lid 18 to secure the filter around the air inlet passages formed in the vacuum lid 18. Accordingly, the flange 54 forms a mounting flange for securing the filter to the vacuum 10. According to the design of the particular vacuum, the filter mounting flange may include tabs or clips which attach the filter to the vacuum. The filter mounting flange may also include a rubber gasket or seal which seals the filter to the vacuum and which may also secure the filter to the vacuum. In one example, the filter 34 may be a bag filter and the flange 54 may include a gasket or seal used to attach the flange to the canister inlet.

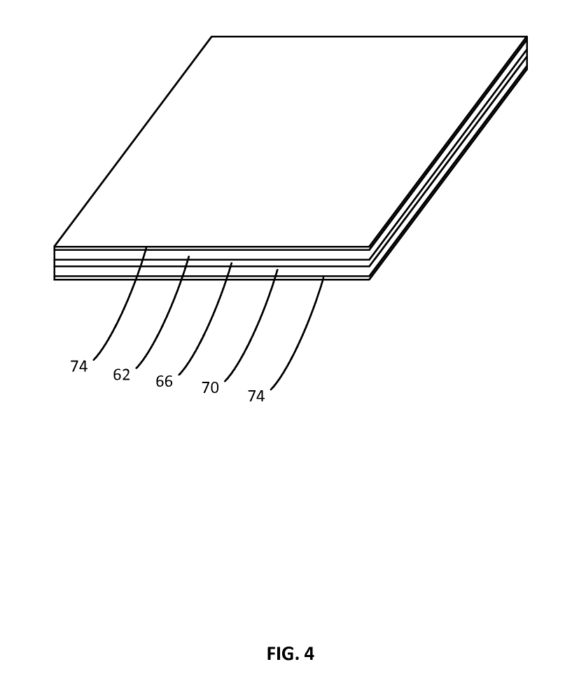

FIG. 4 shows a more detailed view of a portion of the filter material layers, better illustrating the construction of the filter 34. As discussed, the filter material used to construct the filter 34 includes multiple layers of distinct types of materials. The filter 34 includes an outer layer 62 of filter material (i.e. an upstream layer 62), a firebreak layer 66 of fire resistant and structural material, and an inner layer 70 of filter material (i.e. a downstream layer 70). The firebreak layer 66 is disposed as a core layer between the upstream layer 62 of filter material and the downstream layer 70 of filter material. Additionally, the filter material may be coated with a fire resistant/retardant coating material 74. The inner, downstream layer 70 of filter material is located on the face of the filter which is exposed to the vacuum motor 22. The outer, upstream layer 62 of filter material is located on the face of the filter 34 which is exposed to the incoming air and debris. As an example, the outer layer 62 and inner layer 70 of filter material may be a layer of polyester filter material. The polyester filter layers 62 and 70 may be made from a spun bonded material which is between about 0.01 inches and about 0.08 thick, and preferably about 0.06 inches thick. The fire resistant coating 74 may be applied to the polyester filter material 62 and 70 before the layers of material are sewn together into a filter. The fire resistant coating may be a surface treatment and does not fill the pores of the polyester filter material and block its ability to allow air flow and to trap dust and debris. The fire resistant coating may be a coating which penetrates or coats the fibers of the polyester filter material and allows air flow through the filter material pores.

The core layer 66 is preferably made of fiberglass. By way of example, the core layer 66 may be made of a woven fiberglass cloth which is between about 0.02 and about 0.06 inches thick, and is preferably about 0.04 inches thick. The core layer 66 may be made of a fiberglass cloth or woven roving type cloth which is between 10 and 40 ounces per square yard, preferably between 18 and 30 ounces per square yard, and more preferably about 24 ounces per square yard. Typical 24 ounce per square yard fiberglass cloth has a thickness which is about 0.04 inches. The woven fiberglass core 66 is sufficiently tightly woven that there are not any significant openings or holes through the fiberglass. The woven fiberglass allows air flow and does not pose significant restriction to air flow, but will not allow large pieces of debris to pass through the fiberglass.

The filter 34 is assembled so that the outside surface of the filter (i.e. the side of the filter which is exposed to incoming ‘outside’ air and debris) is the fire resistant coating material 74 and the polyester filter material 62 to which the coating is attached. The core 66 is disposed against the outer layer 62 of filter material, and the inner layer 70 of filter material is disposed against the core 66. In some embodiments, it may not be necessary to use a fire resistant coating material on the inner layer 70 of filter material.

In use, dirty air and debris flow through the outer layer 62 of filter material (and fire resistant coating 74) and the outer layer 62 of filter material removes the debris which is entrained in the air. The cleaned air then flows through the woven fiberglass core 66 and through the inner layer 70 of filter material. In the sense of filtration, the inner layer 70 of filter media is redundant as the outer layer 62 of filter media removes the debris from the air. This is particularly true where the outer layer 62 and inner layer 70 of filter media are made from the same type of filter media. In the present example, the outer layer 62 and inner layer 70 of filter media are both made from a spun bonded polyester media which is approximately 0.06 inches thick. Preferably, the outer layer 62 and inner layer 70 are made with a filter material having sufficiently fine pores to collect the majority of fine particulates, such as when a person is vacuuming ash, sheetrock dust, fine dirt, etc. The vacuum bags may be made with a fine enough filter material to be HEPA rated in collecting fine particulates. For example, the filter material used for the outer layer 62 and inner layer 70 may retain particles with sizes down to about 0.5 micron. In an example filter, the downstream layer 70 of filter material has approximately the same filtration efficiency or pore size as the upstream layer 62 of filter material and thus does not capture significant amounts of debris while the upstream layer 62 of filter material is intact and functioning.

The core 66 of woven fiberglass provides a barrier against hot materials such as hot ash, embers, and sparks should the outer layer 62 of filter material fail. As an example, it is not uncommon when vacuuming ash from a fireplace to draw live embers into the vacuum. These hot embers will gradually damage the outer layer 62 of filter material. The air flow through the vacuum filter 34 will often hold embers or the like against the filter 34 and cause the hot ember to melt or burn a hole through the outer layer 62 of filter material. The fiberglass core 66, while not providing a significant amount of filtration, provides structural support to the filter 34 in the event that the outer layer 62 of filter material is damaged. Moreover, the core 66 is highly resistant to hot materials such as embers and will keep the ember from burning through the filter 34. The core 66 protects the inner layer 70 of filter material from the hot debris. Once a hole is melted through the outer layer 62 of filter material, unfiltered air passes through the hole in the outer layer 62 of filter material and passes through the core 66. The core 66 will stop large debris and protects the inner layer 70 of filter material from any hot debris such as embers. The inner layer 70 of filter material then begins filtering the remaining fine debris from the airstream.

As such, the inner layer 70 of filter material and the core 66 do not significantly participate in the filtration until the outer layer 62 of filter material is damaged. At this point, the core 66 becomes active in protecting the inner layer 70 of filter material and the inner layer 70 of filter material becomes active in filtering the dust from the air stream. Until the outer layer 62 of filter material is damaged, dust and debris is deposited on the outside surface of the filter 34 where is can be removed from the filter. Once the outer layer 62 of the filter material is damaged and breached, dust will deposit on the core 66 and inner layer 70 of the filter material where it is not easily cleaned. This dust and debris, however, is prevented from flowing through the impeller 26 and motor 22.

The filter 34 will thus protect the vacuum motor 22 and impeller 26 from damage even after the outer layer 62 of filter material is damaged. The core 66 and inner layer 70 of filter material will typically provide adequate filtration of the air stream until the vacuum canister needs emptying or the filter 34 needs cleaning. At this point, the user will be able to visually identify the damage to the outer layer 62 of filter material and can replace the filter 34.

The undamaged filter 34 is readily cleanable and reusable because the dust and debris is primarily deposited on the outer surface of the filter 34. The filter 34 can thus be shaken or blown off and reused. The filter 34 may be reused until damaged and thus provides an extended service life. Once damaged, the core 66 and inner layer 70 of filter material provide continuing filtration to protect the impeller 26 and motor 22 and prevent damage to the vacuum until the damaged outer layer 62 of filter material is discovered and the filter 34 is replaced.

The above description of illustrated examples of the present invention, including what is described in the Abstract, are not intended to be exhaustive or to be limitation to the precise forms disclosed. While specific examples of the invention are described herein for illustrative purposes, various equivalent modifications are possible without departing from the broader scope of the present claims. Indeed, it is appreciated that specific example dimensions, materials, etc., are provided for explanation purposes and that other values may also be employed in other examples in accordance with the teachings of the present invention.

What is claimed is:

1. A vacuum filter comprising:
a mounting structure configured for attaching the vacuum filter to a vacuum; and
a filter element attached to the mounting structure such air flow through a vacuum flows through the filter element;
wherein the filter element is formed of multiple layers of different material; and
wherein the filter element comprises:
an upstream layer of filter material which is exposed to incoming debris and which filters debris from air moving through a vacuum;
a firebreak layer disposed adjacent the upstream layer of filter material and disposed downstream of the upstream layer of filter material; and
a downstream layer of filter material which is disposed downstream of the firebreak layer.

2. The vacuum filter of claim 1, wherein upstream layer of filter material is a spun bonded polyester.

3. The vacuum filter of claim 1, wherein the upstream layer of filter material is approximately 0.06 inches thick.

4. The vacuum filter of claim 1, wherein the vacuum filter further comprises a fire retardant coating applied to the upstream layer of filter material.

5. The vacuum filter of claim 1, wherein the firebreak layer comprises woven fiberglass.

6. The vacuum filter of claim 5, wherein the woven fiberglass weighs between about 10 and about 40 ounces per square yard.

7. The vacuum filter of claim 5, wherein the woven fiberglass weighs about 24 ounces per square yard.

8. The vacuum filter of claim 1, wherein the downstream layer of filter material is a spun bonded polyester.

9. The vacuum filter of claim 1, wherein the downstream layer of filter material has a filtration efficiency which is approximately the same as a filtration efficiency of the upstream filter material.

10. The vacuum filter of claim 1, wherein the downstream layer of filter material has a pore size which is approximately the same as a pore size of the upstream filter material.

11. The vacuum filter of claim 1, wherein the vacuum filter further comprises a fire retardant coating applied to the downstream layer of filter material.

12. A vacuum filter comprising:
a mounting structure configured for attaching the vacuum filter to a vacuum, the mounting structure having an opening therein; and
a filter element attached to the mounting structure such that air flow through a vacuum flows through the filter element;
wherein the filter element is formed of multiple layers of different material which are attached together; and
wherein the filter element comprises:
an upstream layer of filter material which filters debris from air moving through a vacuum, the upstream layer of filter material having a first side which is exposed to incoming debris and a second side; and
a firebreak layer which is disposed downstream of the upstream layer of filter material, the firebreak layer having a first side which is disposed adjacent the second side of the upstream layer of filter material and a second side.

13. The vacuum filter of claim 12, wherein the filter element further comprises a downstream layer of filter material which is disposed downstream of the firebreak layer, wherein the downstream layer of filter material is disposed adjacent the second side of the firebreak layer.

14. The vacuum filter of claim 12, wherein the firebreak layer comprises woven fiberglass.

15. The vacuum filter of claim 14, wherein the woven fiberglass weighs about 24 ounces per square yard.

16. The vacuum filter of claim 12, wherein upstream layer of filter material is a spun bonded polyester.

17. The vacuum filter of claim 12, wherein the vacuum filter further comprises a fire retardant coating applied to the upstream layer of filter material.

18. The vacuum filter of claim 12, wherein the downstream layer of filter material is a spun bonded polyester.

19. The vacuum filter of claim 12, wherein the downstream layer of filter material has a filtration efficiency which is approximately the same as a filtration efficiency of the upstream filter material.

20. The vacuum filter of claim 12, wherein the downstream layer of filter material has a pore size which is approximately the same as a pore size of the upstream filter material.
